(19) United States
(12) Patent Application Publication
(10) Pub. No.: US 2008/0175013 A1
(43) Pub. Date: Jul. 24, 2008

(54) Multiple Illumination Element Lamp Apparatus

(76) Inventor: Jon F. McClelland, Golden, CO (US)

Correspondence Address: JACKSON ESQUIRE;ROGER A. JACKSON, 1115 GRANT STREET, SUITE G-7, DENVER, CO, 80203-2399, US

(21) Appl. No.: 11/625,823

(22) Filed: Jan. 23, 2007

(51) Int. Cl. B60Q 1/14

(52) U.S. Cl. 362/478; 362/544; 362/545

(57) ABSTRACT

A multiple illumination element lamp apparatus is disclosed of a carriage that includes a proximal reflector having abase and a surrounding sidewall extending from the base to define a proximal reflector interior separated from an exterior environment. The multiple illumination element lamp also includes a first and a second illumination element both disposed within the proximal reflector interior, wherein the first illumination element produces a substantially high brightness light level an the second illumination element produces a substantially low brightness light level. Further, in the multiple illumination lamp the fist and second illumination elements are sized and configured to produce substantially a same light beam shape and projection with the high and low brightness levels.

### TECHNICAL FIELD

The present invention generally relates to a lamp with multiple elements for the purpose of providing different illumination levels along a right of way for a movable carriage. More particularly, the present invention relates to a multiple element lamp for the purpose of providing different illumination levels along a “ditch” being defined as a railroad right of way, wherein the lamp is a headlamp for a railroad above the “ditch” as opposed to specific “ditch” lights that are positioned adjacent to the ditch.

### BACKGROUND OF INVENTION

Typical railroad regulations require that the locomotive headlamps provide multiple illumination levels of the ditch which were typically bright, medium, and dim illumination levels, wherein the trend is towards only requiring bright and dim illumination levels. Further, there are numerous other locomotive lights in addition to locomotive headlights that include multiple light emitting sources such as MARS lights (oscillating beam), ditch specific lights (that are adjacent to the railroad tracks that typically flash when the locomotive approaches a railroad crossing), running lights (for illuminating various parts of the locomotive), side and marker lights (for illuminating the locomotive from positions other than the rail right of way). Returning specifically to locomotive headlights, there are a number of issues leading to the current undesirable features found with current locomotive headlight systems which requires some background description on the development of locomotive electrical systems.

As most current locomotives are diesel powered, electrical power generation aboard the locomotive is typically at about 74 volts DC, wherein the majority of the electrically powered equipment on the train operates at approximately the 74 volt level, with the alternative exception of the headlights that currently typically operate at about 35 volts DC. Wherein the approximately 35 volt headlights were a holdover from the steam locomotive era that typically had an electrical generation system that produced about 35 volts DC and the fact that the approximately 35 volt headlight had a stronger filament (larger cross section area) due primarily to a higher electrical current load in the filament, resulting in a desirable feature of better vibratory shock and fatigue resistance and being less prone to filament failure. The headlight vibration and shock usually comes from locomotives coupling and uncoupling into each other and the normal shock and vibration from the diesel engine and railroad track undulations as the locomotive moves along the tracks. Another stress induced upon the headlight filament is electrical, wherein a shock effect occurs whenever the filament is energized and de-energized, as when the filament is first energized an inrush current that can be as high as 10 times or more of the normal operating current instantaneously occurs, as the filament is essentially a low electrical resistance short circuit for a short period of time before it comes to operating temperature and its electrical resistance increases, with this all happening in about one-tenth of a second. Unfortunately, this dramatic filament temperature change results in strain induced stress upon the filament that acts to weaken the filament over repeated on/off cycles, this phenomenon has been experienced by almost everyone who has witnessed a conventional household light bulb failure when the light was first turned on, wherein the filament usually has a bright flash just prior to filament failure. Thus the aforementioned issues all act to shorten the locomotive headlight life leading to the undesirable result of the increased time and cost of headlight replacements

Currently the electrical necessity in using the approximately 35 volt bulb in the substantially 74 volt system requires a voltage drop from the approximate 74 volt electrical generation power source to the approximately 35 volt headlight, this is typically accomplished by the use of resistors which are higher wattage being over about 200 watts which results in excess heat being produced by the resistors, which if course is wasted electrical energy. Further, there are multiple resistors as the locomotive headlight requirement of the previously mentioned high, medium, and low illumination levels results in the need for different resistance levels as current locomotive headlights utilize a single filament that operates at 3 different voltages to accomplish the aforementioned three illumination levels. In addition, the resistors are added components that are prone to failure and further add to the undesirable result of the increased time and cost of resistor replacement. In modern day electrical control systems, this multiple resistor approach is somewhat of a “sledge hammer” solution as the use of resistors wastes electrical energy and adds to the likelihood of electrical system failure from the additional electrical components, in addition to increased weight and size requirements of the resistors and associated components.

This problem is indirectly recognized in the prior art by the use of digital pulse duty cycle dimming and flashing lighting circuitry systems for locomotives for the elimination of voltage dropping resistors as disclosed in U.S. Pat. No. 5,646,453 to Wetzel et al., that is concerned with flashing “ditch” lights that are utilized when a locomotive approaches a grade crossing, wherein the Wetzel circuitry is operable to “softly” change the voltage to the ditch lights, i.e. the ditch light does not go completely on and off, however, having more of a series of bright/dim operation states so as to better preserve ditch light operational life as previously described, in other words the ditch light experiences fewer full on/full off cycles which reduces the stresses on the filament. Although Wetzel primarily operates to flash locomotive ditch lights and could be used for a locomotive headlight dimming function, the control circuitry is sensitive to the problem of light filament failure that leads to a momentary short circuit when the filament arcs just prior to failure, requiring the need for an over current protector, as the digital circuitry cannot withstand this momentary short circuit. Wetzel does eliminate the undesirable resistors in the locomotive lighting system, however, adding considerable other circuitry as described that is more electrically efficient that resistors, unfortunately though adding complication to the locomotive lighting system that could compromise reliability. In a similar manner in U.S. Pat. No. 5,821,700 to Malvaso disclosed is a light warning system for a locomotive using a digital pulse width modulated (PWM) signal like Wetzel, for the use of low mounted “ditch” lights which flash when the locomotive approaches a rail road crossing. Malvaso has two PWM signal systems for two lighting systems that are each selectively adjustable for Their duty cycles to separately control the “ditch” light flashing intensity, as distinguishing features over Wetzel. Malvaso also has for enhancement of the filament life “soft” voltage changes for the “ditch” lights, such as preheating the filaments, temperature sensing of the filaments, and filament short out sensors that detect whether a “ditch” light has failed. As both Wetzel and Malvaso only disclose locomotive lighting systems for the use of single filament bulbs that either flash or change their illumination levels using digital pulse width modulation control circuitry, other areas of art will be looked to for multiple filament lights as follows in the subsequent section, being prevalent in the automotive and aircraft arts.

Starting with U.S. Pat. No. 5,911,502 to Zillgitt et al., disclosed is a vehicle headlight having high and low beams that are operable through a beam position adjusting device that requires a motor driven mechanism that physically repositions a single filament light bulb into either a high beam position or a low beam position with the motor mechanical control system having a default position of a low beam position. In Zillgitt the primary advantage is the utilization of a single filament bulb to accomplish having a vehicle headlight that is capable of having the low beam and the high beam each optically optimized, however, the negative trade-off being the addition of the motor, its control system, and mechanical linkages for effectuating the repositioning of the single filament light bulb to project the low beam and the high beam. Further, in this area in U.S. Pat. No. 4,480296 to Gagnon et al., disclosed is a single halogen Light bulb containing two filaments for the purpose of creating a low beam and a high beam for a vehicle highlight. Gagnon shows an arrangement of the high and low beam filaments, see FIGS. 4 and 5, to position the low beam filament at the reflector focal point orthogonal to the optical axis and the high beam filament parallel to the optical axis (such that the filaments are at right angles to one another), thus the high beam filament while not being optimum (not at the reflector focal point) being axially positioned superimposed, decreasing narrower beam due to the high beam filament ends being superimposed, decreasing beam spread.

Typically, a vehicle headlight with multiple filaments is designed primarily for optically optimizing either the low beam or the high beam operation, where in the high beam is at best compromised in lighting efficiency for the vehicle driver to spot faraway objects at night, as the vehicle typically uses the low beam for the majority of the time, i.e. such that the low beam is optically optimized by being placed a the focal point of the reflector and the high beam being necessarily positionally displaced away from the focal point of the reflector. Typically, a vehicle headlight low beam has a lighting pattern that normally is of a low intensity with the lighting beam broadly spread horizontally typically oriented downwards toward the road way immediately in front a vehicle, ideally a vehicle headlight high beam would have alighting pattern of a very high intensity having very little ea diffusion and projecting a significant distance directly in front of the vehicle with the high beam being oriented into a position directly in front of the vehicle up and away from the low beam orientation. Henceforth, the compromise being that the high beam filament and the low beam filament must of necessity share the same headlight reflector and projection lens, with the exception of a four automotive head light system wherein two of the headlights are dedicated to high beam operation. However, returning to the typical two automotive head light system, wherein either the high beam or the low beam can be optimized and the non optimized beam is compromised in its efficiency of producing the desired light beam. The prior art in this area has a number of variations in trying to minimize the loss in the desired characteristics of either the low or high light beam, whichever one is not optimized. In the United States automotive area there is typically used a filament arrangement placing the filaments parallel to the road surface and orthogonal (perpendicular) to the axis of the reflector, see U.S. Pat. No. 3,898,451 to Murphy et al., for an example. As a comparison, the typical European automotive design is to place both the high and low beam filaments parallel to the reflector axis being axially displaced from one another with the high beam filament positioned at the reflector focal point and the low beam filament positioned ahead of the high beam filament as disclosed in U.S. Pat. No. 3,646,385 to Wichert, wherein the European design optimizes the high beam and compromises the low beam as being positioned off of the reflector for focal point.

Further, dual filament automotive application arrangements have the low beam filament axially positioned at the reflector focus point and the high beam filament is positioned behind the low beam i.e. closer to the vertex of the reflector being disposed orthogonal to the optical axis as shown in U.S. Pat. No. 3,493,806 to Jacobs et al., yet other arrangements call for a shield between the filaments for directing the high and low beam light patterns shown in U.S. Pat. No. 3,569,693 to Lindae et al. Looking in the aircraft area for landing lights in referring to U.S. Pat. No. 2,791,714 to Beesely disclosed is a dual filament arrangement for the producing a landing beam and a taxiing be am, wherein the high wattage filament is axially disposed on the focus point of the reflector along the optical axis of the reflector and the low wattage filament extends transversely of the reflector axis being disposed adjacent to the focal point of the reflecting surface, wherein the low wattage filament produces a wide floodlight taxiing beam and the high wattage filament produces a circular shaped narrow beam, wherein typically either the low wattage beam is on alone (for taxing) or both the low wattage and the high wattage beams are on (for landing).

Continuing, in looking at United State patent application publication number 2004/0170028A1 to Schug et al., disclosed is a multiple filament automotive vehicle headlamp that utilizes two reflector regions each having its own filament with separation accomplished by a screen positioned between the two filaments. Also, in United States patent application publication number 2002/0145880A1 to Nouet disclosed is a motor vehicle lighting apparatus that uses unique right and left vehicle headlight reflector shapes, thus the main (high) beam from each of the right and left headlights are oppositely offset from one another to produce a more focused efficient beam.

Returning to the locomotive headlight system, with the desired goal being to eliminate the resistors from the locomotive headlight system, the requirement comes into play for matching the voltage of the headlight and the electrical power generating system being needed, or another means for voltage conversion between the locomotive electrical power generation system at 74 volts DC and the locomotive headlight at 35 volts DC would have to be utilized, such as using the pulse width modulation system as previously discussed. Further, the locomotive headlight due to its requirement for at least the high beam and the low beam would also either need dual filaments or have voltage control circuitry to provide at least one lower voltage to a single filament headlight to have a high beam at the direct voltage of about 74 volts DC going directly from the locomotive electrical generator to the headlight high beam and the reduced voltage being used for the headlight low beam. Note that the lexicon of “high” and “low” beam is not directly descriptive of the locomotive headlight requirement in that a “bright” and “dim” beam would be more accurate as a distinguishing feature of locomotive headlights is that the frusto conical shape of the light beam need not change between “bright” and “dim” as the lighting path for the locomotive headlight is basically unchanged with only the illumination levels changing. This is as opposed to the previously discussed automotive application wherein the beam shape, aim, and focus is desirably different between the high and low beam, i.e. the low beam being highly diffused horizontally and aimed directly in front of the vehicle and the high beam being narrowly focused at a distance away from the vehicle.

Returning to the present invention of a locomotive headlight, for simplicity, it would be most desirable to eliminate any type of voltage control circuitry such that all the desired capabilities are put into a single headlight such that the headlight has a dual filament wherein one filament is the bright beam an the other filament is the dim beam, with both filaments operating at the locomotive generator voltage of about 74 volts DC resulting in the elimination of voltage drop resistors or any other type of voltage control circuitry. The filaments would preferably be tungsten carbide with alternative other lighting elements such as halogen, xenon, LED, and the like that could be utilized.

### SUMMARY OF INVENTION

Broadly, the present invention of a multiple illumination element lamp apparatus for a carriage includes a proximal reflector having a base and a surrounding sidewall extending from the base to define a proximal reflector interior separated from an exterior environment. The multiple illumination element lamp also includes a first and a second illumination element both disposed within the proximal reflector interior, wherein the first illumination element produces a substantially high brightness light level and the second illumination element produces a substantially low brightness light level. Further, in the multiple illumination lamp the fist and second illumination elements are sized and configured to produce substantially a same light beam shape and projection with the high and low brightness levels.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of a multiple illumination element lamp apparatus;

FIG. 2 shows a cross section view of a proximal reflector and a lens;

FIG. 3 shows a cross section view of the proximal reflector, the lens, and a distal reflector;

FIG. 4 shows a cross section view of the proximal reflector and the lens with a first illumination element and a second illumination element that are oriented in a substantially transverse manner including reflection of the first and second illumination element brightness by the proximal reflector and a non reflected illumination element brightness;

FIG. 5 shows a cross section view of the proximal reflector, a distal reflector, and the lens with the first illumination element and the second illumination element that are oriented in a substantially transverse manner including reflection of the first and second illumination element brightness by the proximal reflector and the distal reflector;

FIG. 6 shows a cross section view of the proximal reflector and the lens with the first illumination element and the second illumination element that are oriented in a substantially juxtapose manner including reflection of the first and second illumination element brightness by the proximal reflector and the non reflected illumination element brightness;

FIG. 7 shows a cross section view of the proximal reflector, the distal reflector, and the lens with the first illumination element and the second illumination element that are oriented in a substantially juxtapose manner including reflection of the first and second illumination element brightness by the proximal reflector and the distal reflector;

FIG. 8 shows a schematic of the first illumination element and the second illumination element that are all preferably operated at substantially the same voltage, wherein the first and second illumination elements are independently illuminated.

FIG. 9 shows a schematic of the first illumination element, the second illumination element, and the third illumination element that are all preferably operated at substantially the same voltage, wherein the first, second, and third illumination elements are independently illuminated; and

FIG. 10 shows a use view of the multiple illumination element apparatus disposed as a locomotive headlight specifically showing a ditch adjacent light beam shape and light beam projection for the first, second, and third illumination elements.

### REFERENCE NUMBERS IN DRAWINGS

30 Multiple illumination element lamp apparatus

32 Carriage

34 Locomotive

36 Locomotive 34 headlamp

37 Lens

38 Proximal reflector

39 Base for proximal reflector 38

40 Surrounding sidewall for the proximal reflector 38

42 Interior of the proximal reflector 38

44 Focal point of the proximal reflector 38

46 Distal reflector

48 Base for the distal reflector 46

50 Surrounding sidewall for the distal reflector 46

52 Interior for the distal reflector 46

54 Reflection of first 62 and second 80 illumination element beam brightness 64 and 82 respectively by distal reflector 46

56 Reflection of first 62 and second 80 illumination element beam brightness 64 and 82 respectively by the combination of the distal reflector 46 and the proximal reflector 38

58 Reflection of first 62 and second 80 illumination element beam brightness 64 and 82 by proximal reflector 38

59 Non reflected first 62, second 80, or third 98 illumination element beam brightness 64, 82, or 100 respectively

60 Exterior environment

61 Ditch

62 First illumination element

64 Substantially high light level brightness of the first illumination element 62

66 Longitudinal axis of the first illumination element 62

68 Light beam shape of first illumination element 62

70 Light beam projection of first illumination element 62

72 Tungsten carbide first illumination element filament 62

74 Tungsten halogen first illumination element 62

76 Xenon metal halide high intensity discharge first illumination element 62

78 Light Emitting Diode (LED) first illumination element 62

80 Second illumination element

82 Substantially low light level brightness of the second illumination element 80

84 Longitudinal axis of the second illumination element 80

86 Light beam shape of second illumination element 80

88 Light beam projection of second illumination element 80

90 Tungsten carbide second illumination element filament 80

92 Tungsten halogen second illumination element 80

94 Xenon metal halide high intensity discharge second illumination element 80

96 Light Emitting Diode (LED) second illumination element 80

98 Third illumination element

100 Substantially intermediate light level brightness of the third illumination element 98

102 Longitudinal axis of the third illumination element 98

104 Light beam shape of third illumination element 98

106 Light beam projection of third illumination element 98

108 Tungsten carbide third illumination element 98

110 Tungsten halogen third illumination element filament 98

112 Xenon metal halide high intensity discharge third illumination element 98

114 Light Emitting Diode (LED) third illumination element 98

116 Approximately transverse position of the first illumination element 62 longitudinal axis 66 and the second illumination element 80 longitudinal axis 84

118 Approximately juxtapose position of the first illumination element 62 longitudinal axis 66 and the second illumination element 80 longitudinal axis 84

120 Plane of first illumination element 62 longitudinal axis 66 and second illumination element 80 longitudinal axis 84 approximately transverse position 116

122 Plane of first illumination element 62 longitudinal axis 66 and second illumination element 80 longitudinal axis 84 approximately juxtapose position 118

### DETAILED DESCRIPTION

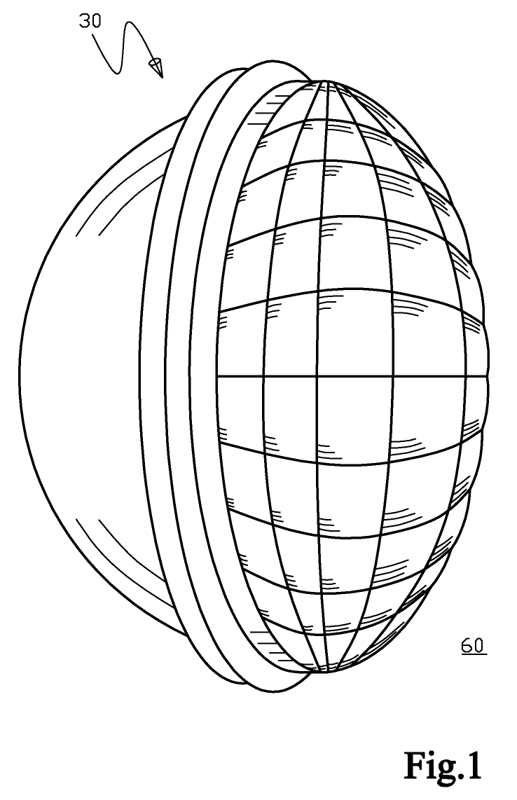

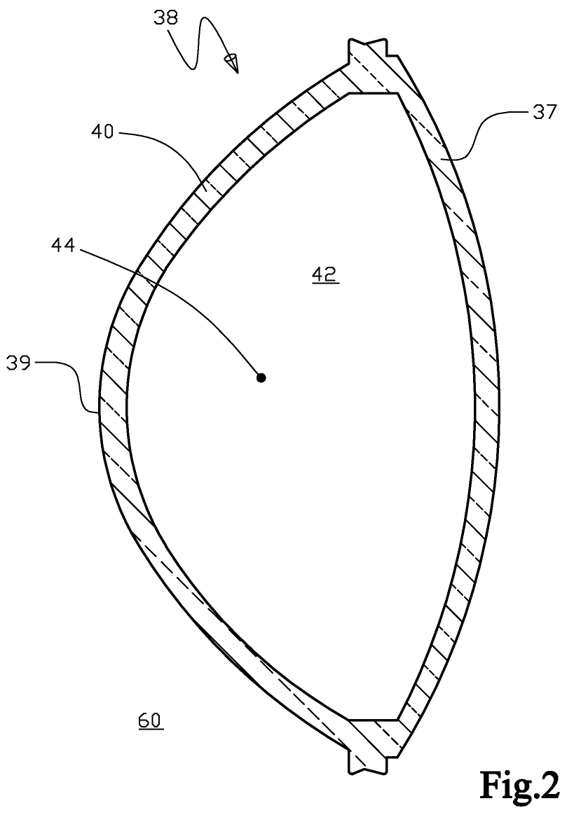

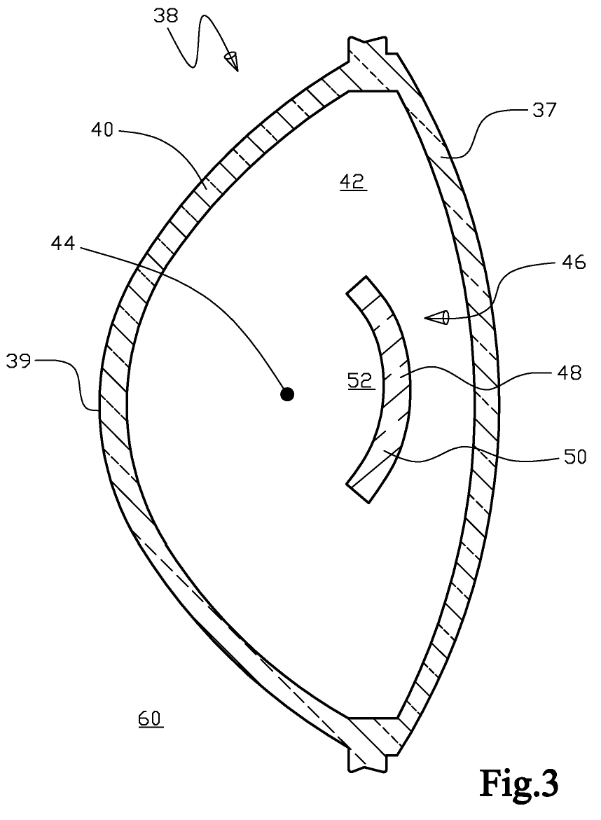

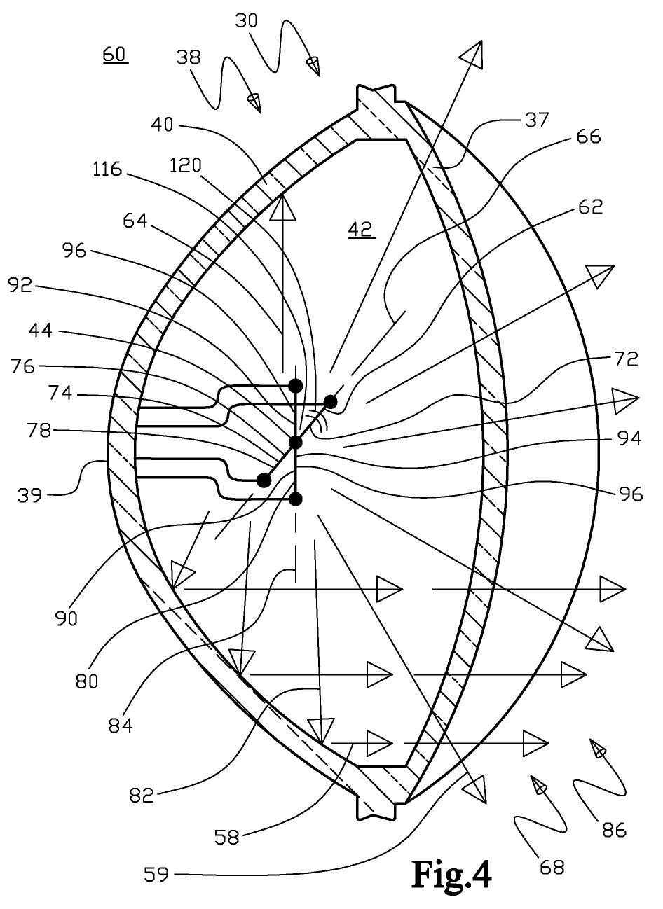

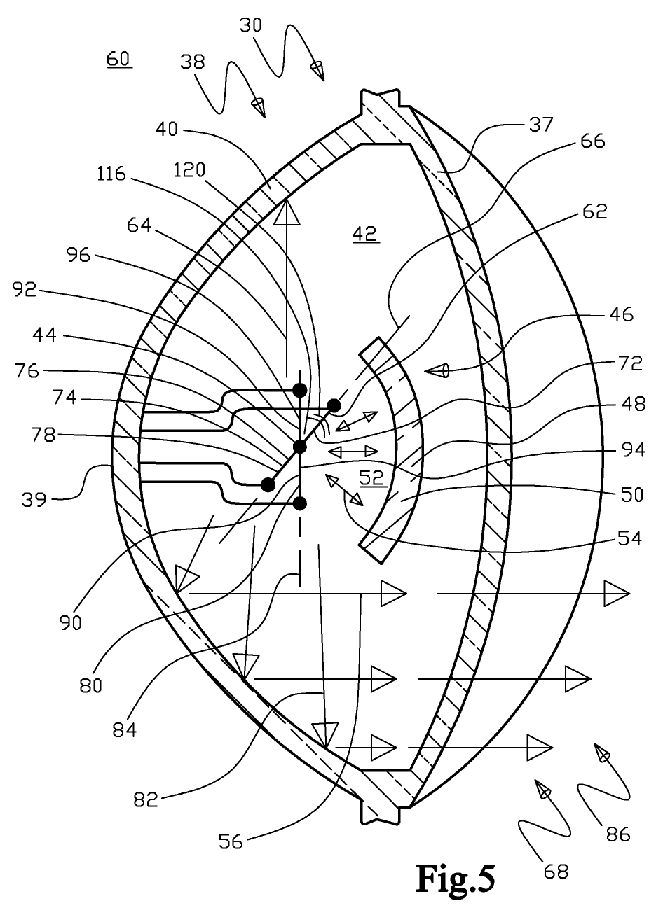

Broadly, with initial reference to FIG. 1 shown is a perspective view of the multiple illumination element lamp apparatus 30, FIG. 2 shows a cross section view of a proximal reflector 38 and a lens 37, and FIG. 3 shows a cross section view of the proximal reflector 38, the lens 37, and a distal reflector 46. Continuing, FIG. 4 shows a cross section view of the proximal reflector 38 and the lens 37 with a first illumination element 62 and a second illumination element 80 that are oriented in a substantially transverse 116 manner or position including reflection of the first 62 and second 80 illumination element brightness 64 and 82 respectively by the proximal reflector 38 and a non reflected illumination element brightness 59. Further, FIG. 5 shows a cross section view of the proximal reflector 38, a distal reflector 46, and the lens 37 with the first illumination element 62 and the second illumination element 80 that are oriented in a substantially transverse 116 manner or position including reflection of the first 62 and second 80 illumination element brightness 64 and 82 respectively by the proximal reflector 38 and the distal reflector 46.

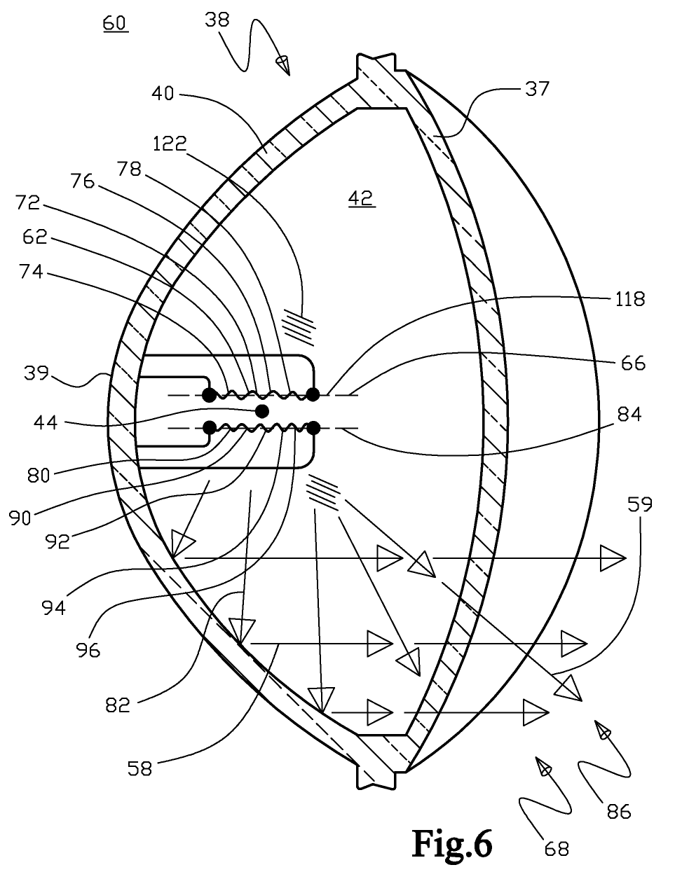

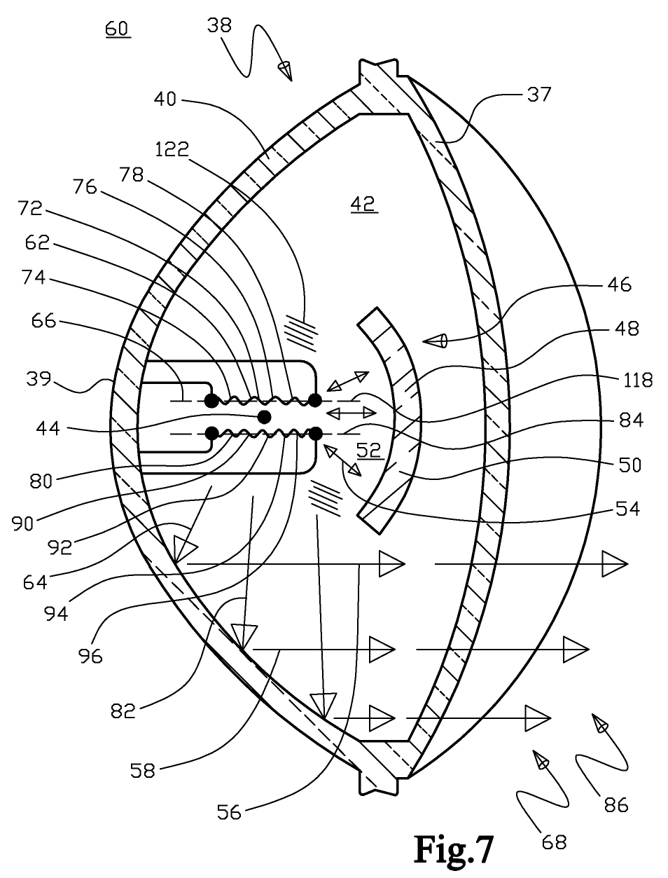

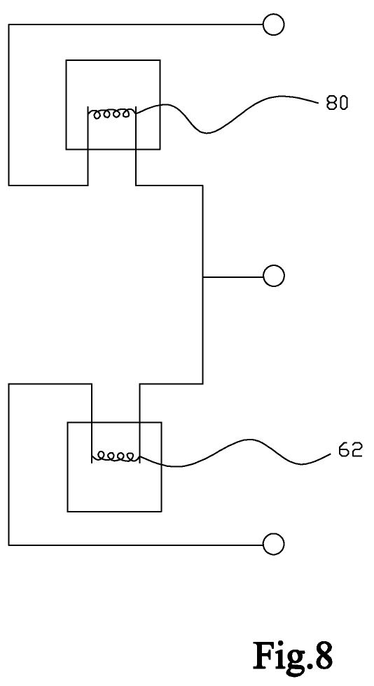

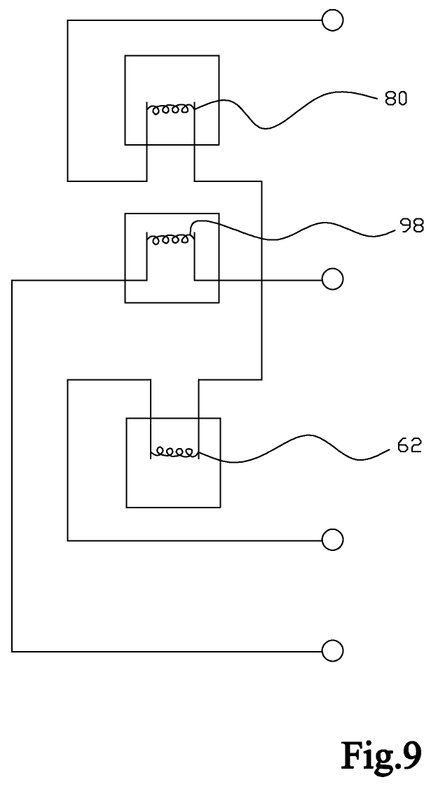

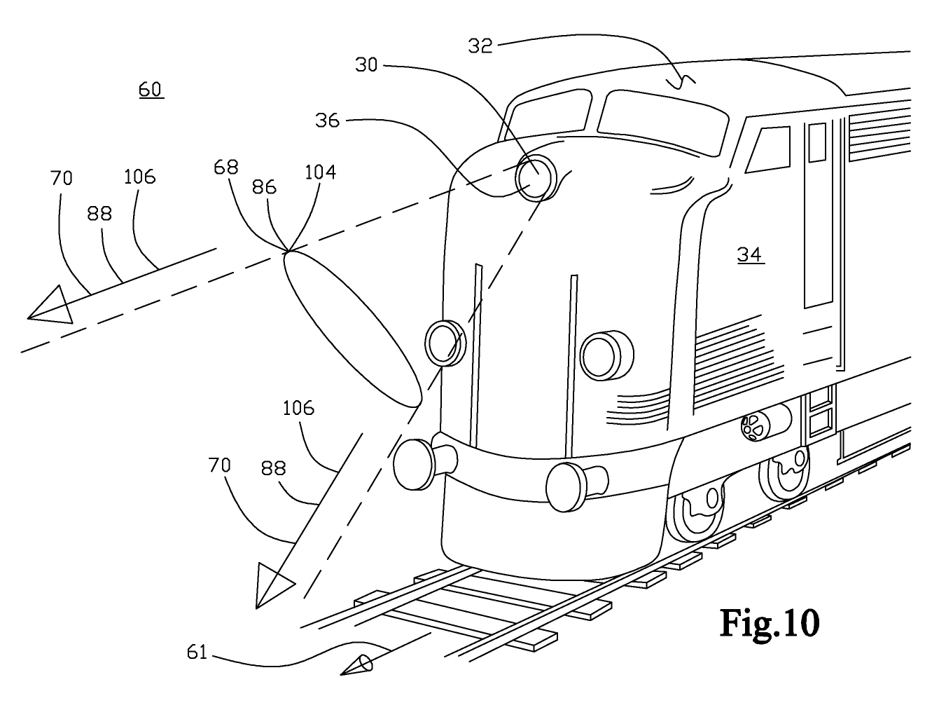

Next, FIG. 6 shows a cross section view of the proximal reflector 38 and the lens 37 with the first illumination element 62 and the second illumination element 80 that are oriented in a substantially juxtapose 118 manner or position including reflection of the first 62 and second 80 illumination element brightness 64 and 82 respectively by the proximal reflector 38 and the non reflected 59 illumination element 62, 80, or 98 brightness 64, 82, or 100 respectively. Further continuing, FIG. 7 shows a cross section view of the proximal reflector 38, the distal reflector 46, and the lens 37 with the first illumination element 62 and the second illumination element 80 that are oriented in a substantially juxtapose 118 manner or position including reflection of the first 62 and second 80 illumination element brightness 64 and 82 respectively by the proximal reflector 38 and the distal reflector 46. Moving onward, FIG. 8 shows a schematic of the first illumination element 62 and the second illumination element 80 that are all preferably operated at substantially the same voltage, wherein the first 62 and second 80 illumination elements are independently illuminated. Next, FIG. 9 shows a schematic of the first illumination element 62, the second illumination element 80, and the third illumination element 98 that are all preferably operated at substantially the same voltage, wherein the first 62, second 80, and third 98 illumination elements are independently illuminated. Further, FIG. 10 shows a use view of the multiple illumination element apparatus 30 disposed as a locomotive 34 headlight specifically showing a ditch 61 adjacent to the light beam shape 68, 86, or 104 respectively and light beam projection 70, 88, or 106 respectively for the first 62, second 80, and third 98 illumination elements.

The multiple illumination element lamp apparatus 30 for a carriage 32 in referring to FIGS. 1 and 10 is shown, broadly includes a proximal reflector 38 having a base 39 and a surrounding sidewall 40 extending from the base 39 to define a proximal reflector 38 interior 42 separated from an exterior environment 60 also including the lens 37 as best shown in FIG. 2. Preferably, the proximal reflector 38 and lens 37 combination is what is commonly known in the locomotive arts as a PAR 56 enclosure utilizing a clear lens 37, see FIG. 2, wherein the PAR 56 enclosure is adapted to be received into also what is commonly know in the locomotive arts as a Type 56 receptacle, see FIG. 10, that is disposed in a typical position on the locomotive 34 as best shown in FIG. 10. Alternative enclosure types would also be acceptable as would a specifically designed enclosure and mating receiving receptacle is desired, either in being sized and configured for use as a locomotive headlight or especially in the case of using the multiple illumination element lamp apparatus 30 in an application other than a locomotive. Further included in the multiple illumination element lamp apparatus 30 is a first 62 and a second 80 illumination element that are both disposed within the proximal reflector 38 interior 42, as best shown in FIGS. 4 and 6, wherein in FIGS. 4 and 6 are rotated slightly clockwise about a hypothetical vertical axis (not shown) as compared to FIG. 2, thus having the extra line outward of the lens 37. The first illumination element 62 produces a substantially high brightness light level 64 and the second illumination element 80 produces a substantially low brightness light level 82. The first 62 and second 80 illumination elements are sized and configured to produce substantially a same light beam shape 68 and 86 respectively and projection 70 and 88 with the high 64 and low 82 brightness levels. Note that this requires the positioning of the first 62 and second 80 illumination elements such that their respective positioning is substantially symmetric about the proximal reflector 38 focal point 44. Wherein when each of the first 62 and second 80 illumination elements put forth very much alike reflection 58 beam patterns to help keep the beam projection 70 and 88 respectively including the beam shape 68 and 86 respectively alike with the difference being that the first illumination element 62 outputs a substantially high light level of brightness 64 and the second illumination element 80 outputs a substantially low level of brightness 82. With the result that the first 62 and second 80 illumination elements each one independently or together both output a similar light beam shape 68 and 86 respectively plus light beam projection 70 and 88 respectively, see FIG. 10. This is as contrasted to say for instance the automotive arts for headlights wherein the different brightness beams have different shapes and projections as per the functional needs of an auto as compared to a carriage 32 or locomotive 34 that is on tracks such that the locomotive 34 needs to be seen and doesn't have the ability to alter its path of travel. Wherein an auto must contend with other oncoming autos and their headlights, plus having the ability to alter its path of travel as previously discussed in the field and background section.

As an option for the multiple illumination element apparatus 30, alternatively included is a third illumination element 98 that is also disposed within the proximal reflector 38 interior 42. However, the third illumination element 98 is not shown in FIGS. 4 and 6, as the third illumination element 98 would just be added to the interior 42, with the previously discussed requirement of substantially positioning the multiple illumination elements about the proximal reflector 38 focal point 44 in a symmetric manner utilizing the third illumination element 98 longitudinal axis 102 as a positioning gage, such that the third illumination element 98 produces a substantially intermediate brightness light level 100 in relation to the previously mentioned high 64 and low 82 brightness light levels. Thus, the third illumination element 98 sized and configured to produce a light beam shape 104 and projection 106 that is substantially the same as the light beam shape 68 and 86 respectively and projection 70 and 88 respectively for the first 62 and second 80 illumination elements.

Further, as another option on the multiple illumination element lamp apparatus 30 the first 62, second 80, and third 98 illumination elements can be sized an configured to operate at substantially the same voltage. Or alternatively, the multiple illumination element lamp apparatus 30 the first 62 and second 80 illumination elements are sized and configured to operate at substantially the same voltage. Preferably the substantially same voltage is about seventy four (74) volts direct current (74 VDC) representing the electrical power generation system on a current locomotive 34, however, other voltages in an absolute sense would also be acceptable as long as all of the aforementioned illumination elements being the first 62, second 80, and third 98 were at substantially the same voltage.

In addition, for the multiple illumination element lamp apparatus 30, the first 62, second 86, and third 98 illumination elements can either have like or different constructions in any particular combination the following illumination element types, starting with a conventional tungsten carbide 72, 90, or 108 respectively, or a tungsten halogen 74, 92, or 110 respectively, or a xenon metal halide high intensity discharge 76, 94, or 112 respectively, or a light emitting diode (LED) 78, 96, or 114 respectively, or any other type of illumination element that can meet a peak brightness of about two hundred and seventy thousand (270,000) center beam candle power (CBCP).

Further, for optional alternative illumination element positioning for the multiple illumination element lamp apparatus 30 focusing specifically on the first 62 and second 80 illumination elements that are constructed of the previously described tungsten carbide filaments 72 and 90 respectively, wherein the first tungsten carbide element 72 has a first longitudinal axis 66 and the second tungsten carbide element 90 having a second longitudinal axis 84 as best shown in FIGS. 4 and 5. Next, in focusing upon the first tungsten carbide filament 72 first longitudinal axis 66 an the second tungsten carbide filament 90 second longitudinal axis 84 are positioned approximately transverse 116 to one another in substantially the same plane 120 adjacent to the focal point 44 of the proximal reflector 38. Thus this approximately transverse 116 positioning is to position the first 62 and second 80 illumination elements substantially symmetric about the focal point 44 to allow the beam shape 68 and 86 respectively and beam projection 70 and 88 respectively remain substantially consistent from each of the first 62 and second 80 illumination elements. The first 62 and second 80 illumination elements are either illuminated independently or together as transmitted via the beam reflection 58 by the proximal reflector 38 and the non reflected beam brightness 59 as best shown in FIG. 4. In addition, the fist 62 and second 80 illumination elements as shown in FIG. 4 are not necessarily in contact with one another as they are adjacent to one another in substantially the same plane 120 and also being adjacent to the focal point 44. Also, the third illumination element 98 could optionally be added in the same plane 120 by modifying the transverse 116 positioning to a three substantially equally spaced illumination elements 62, 80, and 98 respectively forming about sixty degree (60 degree) angles between each of the three illumination elements 62, 80, and 98 respectively.

As a further enhancement to controlling the reflected brightness 58 of the beam, or in other words to assist in eliminating the non reflected illumination element beam brightness 59 that is in essence non controlled light diffusion, the multiple illumination element lamp apparatus 30 further can optionally include a distal reflector 46 having a base 48 and a surrounding sidewall 50 extending from the base 48 to define a distal reflector 46 interior 52 separated from the exterior environment 60, as best shown in FIG. 5. The distal reflector 46 is positioned such that the distal reflector 46 interior 52 faces the proximal reflector 38 interior 42, wherein the first 72 and second 90 tungsten carbide filaments are positioned therebetween the distal reflector interior 52 and the proximal reflector interior 42. The distal reflector 46 is operational to reflect the first 72 and second 90 filament brightness 54 such that substantially all of the brightness 56 is reflected by the proximal reflector 38. This results in substantially all of the first 62 and second 80 illumination element beam brightness 56 being reflected by the proximal reflector 38 resulting in better control of the beam shape 68, 86, and 104 respectively and beam projection 70, 88, and 106 respectively, wherein the loss of the non reflected beam brightness 59 is overcome by the increase in beam brightness 56 being the combination of the distal reflector 46 and the proximal reflector 38. As in FIG. 4, in FIG. 5 this approximately transverse 116 positioning is to potion the first 62 and second 80 illumination elements substantially symmetric about the focal point 44 to allow the beam shape 68 and 86 respectively and beam projection 70 and 88 respectively remain substantially consistent from each of the first 62 and second 80 illumination elements either illuminated independently or together as transmitted via the beam reflection 56 by the proximal reflector 38 and the distal reflector 46 as best shown in FIG. 5. In addition, the first 62 and second 80 illumination elements as shown in FIG. 5 are not necessarily in contact with one another as they are adjacent to one another in substantially the same plane 120 and also being adjacent to the focal point 44. Also, the third illumination element 98 could optionally be added in the same plane 120 by modifying the transverse 116 positioning to a three substantially equally spaced illumination elements 62, 80, and 98 respectively forming about sixty degree (60 degree) angles between each of the three illumination elements 62, 80, and 98 respectively.

Continuing further, for another optional alternative illumination element positioning for the multiple illumination lamp apparatus 30 focusing specifically on the first 62 and second 80 illumination elements that are constructed of the previously described tungsten carbide filaments 72 and 90 respectively, wherein the first tungsten carbide element 72 has a first longitudinal axis 66 and the second tungsten carbide element 90 having a second longitudinal axis 84 as best shown in FIGS. 6 and 7. Next, in focusing upon the first tungsten carbide filament 72 first longitudinal axis 66 and the second tungsten carbide filament 90 second longitudinal axis 84 are positioned approximately juxtapose 118 to one another in substantially the same plane 122 adjacent to the focal point 44 of the proximal reflector 38. Thus, this approximately juxtapose 118 positioning is to position the first 62 and second 80 illumination elements substantially symmetric about the focal point 44 to allow the beam shape 68 and 86 respectively and beam projection 70 and 88 respectively remain substantially consistent from each of the first 62 and second 80 illumination elements either illuminated independently or together as transmitted via the beam reflection 58 by the proximal reflector 38 an the non reflected beam brightness 59 as best shown in FIG. 6. In addition, the first 62 and second 80 illumination elements as shown in FIG. 6 are not necessarily in contact with one another as they are adjacent to one another in substantially the same plane 122 and also being adjacent to the focal point 44. Also, the third illumination element 98 could optionally be added in a symmetric manner about the focal point 44, thus the first 62, second 80, and third 98 illumination elements could be substantially equally spaced, with about a one hundred and twenty degree (120 degree) angle between each of the three illumination elements 62, 80, and 98 respectively that remain in substantially a juxtapose 118 positional relationship to one another about the focal point 44.

As a further enhancement to controlling the reflected brightness 58 of the beam, or in other words to assist in eliminating the non reflected illumination element beam brightness 59 that is in essence non controlled light diffusion, the multiple illumination element lamp apparatus 30 further can optionally include a distal reflector 46 having a base 48 and a surrounding sidewall 50 extending from the base 48 to define a distal reflector 46 interior 52 separated from the exterior environment 60, as best shown in FIG. 7. The distal reflector 46 is positioned such that the distal reflector 46 interior 52 faces the proximal reflector 38 interior 42, wherein the fist 72 and second 90 tungsten carbide filaments are positioned therebetween the distal reflector interior 52 an the proximal reflector interior 42. The distal reflector 46 is operational to reflect the first 72 and second 90 filament brightness 54 such that substantially all of the brightness 56 is reflected by the proximal reflector 38. This results in substantially all of the first 62 and second 80 illumination element beam brightness 56 being reflected by the proximal reflector 38 resulting in better control of the beam shape 68, 86, and 104 respectively and beam projection 70, 88, and 106 respectively, wherein the loss of the non reflected beam brightness 59 is overcome by the increase in beam brightness 56 being the combination of the distal reflector 46 and the proximal reflector 38. As in FIG. 6, in FIG. 7 this approximately juxtapose 118 positioning is to position the first 62 and second 80 illumination elements substantially symmetric about the focal point 44 to allow the beam shape 68 and 86 respectively and beam projection 70 and 88 respectively remain substantially consistent from each of the first 62 and second 80 illumination elements either illuminated independently or together as transmitted via the beam reflection 56 by the proximal reflector 38 and the distal reflector 46 as best shown in FIG. 7. In addition, the first 62 and second 80 illumination elements as shown in FIG. 7 are not necessarily in contact with one another as they are adjacent to one another in substantially the same plane 122 and also being adjacent to the focal point 44. Also, the third illumination element 98 could optionally be added in a symmetric manner about the focal point 44, thus the first 62, second 80, and third 98 illumination elements could be substantially equally spaced, with about a one hundred and twenty degree (120 degree) angle between each of the three illumination elements 62, 80, and 98 respectively that remain in substantially a juxtapose 118 positional relationship to one another about the focal point 44.

### CONCLUSION

Accordingly, the present invention of the multiple illumination element lamp apparatus 30 has been described with some degree of particularity directed to the embodiments of the present invention. It should be appreciated, though, that the present invention is defined by the following claims construed in light of the prior art so modifications of the changes may be made to the exemplary embodiments of the present invention without departing from the inventive concepts contained therein.

1. A multiple illumination element lamp apparatus for a carriage, comprising:
(a) a proximal reflector having a base and a surrounding sidewall extending from said base to define a proximal reflector interior separated from an exterior environment; and
(b) a first and a illumination element both disposed within said proximal reflector interior, wherein said first illumination element produces a substantially high brightness light level and said illumination element produces a substantially low brightness light level, said fist and second illumination elements are sized and configured to produce substantially a same light beam shape and projection with said high and low brightness levels.

2. A multiple illumination element lamp apparatus according to claim 1 further comprising a third illumination element that i also disposed within said proximal reflector interior, wherein said third illumination element produces a substantially intermediate brightness light level in relation to said high and low brightness light levels, with said third illumination element sized and configured to produce a light beam shape and projection that is substantially the same as said light beam shape and projection for said first and second illumination elements.

3. A multiple illumination element lamp apparatus according to claim 2 wherein said first, second, and third illumination elements are sized and configured to operate at substantially the same voltage.

4. A multiple illumination element lamp apparatus according to claim 1 wherein said first and second illumination elements are sized and configured to operate at substantially the same voltage.

5. A multiple illumination element lamp apparatus according to claim 1 wherein said first and second illumination elements are constructed of Light Emitting Diodes (LEDs).

6. A multiple illumination element lamp apparatus according to claim 1 wherein said first and second illumination elements are constructed of a tungsten halogen type.

7. A multiple illumination element lamp apparatus according to claim 1 wherein said first and second illumination elements are constructed of a xenon metal halide high intensity discharge type.

8. A multiple illumination element lamp apparatus according to claim 1 wherein said first and second illumination elements are constructed of first and second tungsten carbide filaments, said first tungsten carbide element having a first longitudinal axis and said second tungsten carbide element having a second longitudinal axis.

9. A multiple illumination element lamp apparatus according to claim 8 wherein said first tungsten carbide filament first longitudinal axis and said second tungsten carbide filament second longitudinal axis are positioned approximately transverse to one another in substantially the same plane adjacent to a focal point of said proximal reflector.

10. A multiple illumination element lamp apparatus according to claim 9 further comprising a distal reflector having a base and a surrounding sidewall extending from said base to define a distal reflector interior separated from the exterior environment, said distal reflector positioned such that said distal reflector interior faces said proximal reflector interior, wherein said first and second tungsten carbide filaments are positioned therebetween said distal and proximal reflector interiors, said distal reflector is operational to reflect said first and second filament brightness such that substantially all of said high and low brightness is reflected by said proximal reflector.

11. A multiple illumination element lamp apparatus according to claim 8 wherein said first tungsten carbide filament first longitudinal axis and said second tungsten carbide element second longitudinal axis are positioned approximately juxtapose to one another in substantially the same plane adjacent to a focal point of said proximal reflector.

12. A multiple illumination element lamp apparatus according to claim 11 further comprising a distal reflector having a base and a surrounding sidewall extending from said base to define a distal reflector interior separated from the exterior environment, said distal reflector positioned such that said distal reflector interior faces said proximal reflector interior, wherein said first and second tungsten carbide filaments are positioned therebetween said distal and proximal reflector interiors, said distal reflector is operational to reflect said first and second filament brightness such that substantially all of said high and low brightness is reflected by said proximal reflector.

13. A multiple illumination element lamp apparatus for a locomotive headlight, comprising:
(a) a proximal reflector having a base and a surrounding sidewall extending from said base to define a proximal reflector interior as separated from an exterior environment; and
(b) a first and a second tungsten carbide filament both disposed within said proximal reflector interior, wherein said first tungsten carbide filament produces a substantially high brightness light level and said second tungsten carbide filament produces a substantially low brightness light level, said fist and second tungsten carbide filaments are sized and configured to produce substantially a same light beam shape and projection with said high and low brightness levels.

15. A multiple illumination element lamp apparatus according to claim 14 wherein said first and second tungsten carbide filaments are sized and configured to operate at substantially the same voltage.
